(19) United States
(12) Patent Application Publication
(10) Pub. No.: US 2008/0211198 A1
(43) Pub. Date: Sep. 4, 2008

(54) Load Sensing Wheel Support Knuckle Assembly and Method for Use

(75) Inventor: Mark A. Joki, Dover, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: THE TIMKEN COMPANY, South Canton, OH (US)

(21) Appl. No.: 11/997,792

(22) PCT Filed: Aug. 11, 2006
(86) PCT No.: PCT/US2006/031220

§ 371 Date: Feb. 4, 2008

Related U.S. Application Data
(60) Provisional application No. 60/707,462, filed on Aug. 11, 2005.

(51) Int. Cl. B60G 17/019

(52) U.S. Cl. 280/5.503

(57) ABSTRACT

A method and apparatus for providing a measurement of wheel forces (Fx, Fy, Fz) on a vehicle wheel assembly (10) to enhance safety by providing electronic braking and power train controls with information about vehicle loading and road surface conditions. The apparatus includes a pair of beams (A, B) coupling an inner knuckle (22) to an outer knuckle (20) upon which the vehicle wheel assembly (10) is mounted. Strain sensors (S_{A}, S_{B}) mounted to the beams (A, B) provide measures of longitudinal bending of beams (A, B). A ball joint (26) for attachment of additional suspension components is coupled to the outer knuckle (20) by a beam (C), and a load sensor (SC) disposed on beam C measures the horizontal lateral forces exerted thereon. Signal from the sensors (S_{A}, S_{B}, S_{C}) are processed to identify component forces (Fx, Fy, Fz) acting on the wheel assembly (10).

### CROSS-REFERENCE TO RELATED APPLICATIONS

The present application is related to, and claims priority from, U.S. Provisional Patent Application Ser. No. 60/707,462 filed on Aug. 11, 2005, which is herein incorporated by reference.

### TECHNICAL FIELD

The present invention is related generally to an assembly for measuring the forces and loads exerted on vehicle components during vehicle operations, and in particular, to an assembly for the measurement of forces and loads exerted on a vehicle wheel assembly and supporting suspension components during vehicle operation.

### BACKGROUND ART

Information relating to the dynamic forces and loads exerted on a vehicle wheel assembly during the operation of a motor vehicle, such as a passenger car or light truck can enhance the safety and operation of the vehicle by providing vehicle control systems, such as a brake control system or a vehicle power train control system with information about vehicle wheel assembly loading and road surface conditions. As a vehicle is driven, loads continually shift between the various wheel assemblies and supporting suspension components, such as in response to the acceleration or deceleration of the vehicle, turning of the vehicle, or the condition of the road or surface over which the vehicle is traveling. Varying loads on each wheel assembly may vary the frictional forces between a tire of the wheel assembly and the road surface, limiting how much driving torque can be delivered to the wheel assembly before slippage occurs, or how much braking force can be effectively applied to the wheel assembly.

Accordingly, it would be advantageous to provide a measurement system for use with a vehicle wheel assembly and supporting suspension system to provide measurements of lateral and longitudinal loads on a vehicle wheel assembly, as well as vertical loads on the vehicle wheel assembly.

### SUMMARY OF INVENTION

The present invention provides a vehicle wheel assembly support structure, i.e. a support knuckle, with a set of load sensors. Each load sensor in the set of load sensors is responsive to forces along at least one axis, and is selectively disposed within the vehicle wheel assembly support structure, such that evaluation of the responses from the set of sensors yields measurements which are representative of the lateral, longitudinal, and vertical forces at a point of contact between a tire of the vehicle wheel assembly and the surface on which it is disposed.

In an embodiment of the present invention, a vehicle wheel assembly support structure is provided which consists of an inner support knuckle and an outer support knuckle to which a vehicle wheel assembly is operatively coupled. The inner and outer support knuckles are interconnected by a pair of horizontal beams upon which strain sensors are disposed for measuring bending along the longitudinal axis of the beam. A ball joint coupling for a suspension member is additionally coupled to the outer support knuckle by a horizontal beam, on which a third strain sensor is disposed to provide a measure of horizontal lateral forces exerted on the ball joint. Signals representative of the bending moments exerted on the interconnecting horizontal beams, and the horizontal lateral force, may be processed to discretely identify longitudinal, lateral, and vertical forces exerted on the vehicle wheel assembly at a contact point with the ground.

The foregoing features, and advantages of the invention as well as presently preferred embodiments thereof will become more apparent from the reading of the following description in connection with the accompanying drawings.

### BRIEF DESCRIPTION OF THE DRAWINGS

In the accompanying drawings which form part of the specification:

FIG. 1 is a partial view of a vehicle right front wheel assembly and supporting structure viewed from the front of the vehicle;

FIG. 2 is a top view of the wheel assembly supporting structure of FIG. 1;

FIG. 3 is a view of the wheel assembly supporting of FIG. 1 as seen from the rear of the vehicle; and

FIG. 4 is a schematic version of forces and moments acting on the components of FIG. 1.

Corresponding reference numerals indicate corresponding parts throughout the several figures of the drawings.

### BEST MODES FOR CARRYING OUT THE INVENTION

The following detailed description illustrates the invention by way of example and not by way of limitation. The description enables one skilled in the art to make and use the invention, and describes several embodiments, adaptations, variations, alternatives, and uses of the invention, including what is presently believed to be the best mode of carrying out the invention.

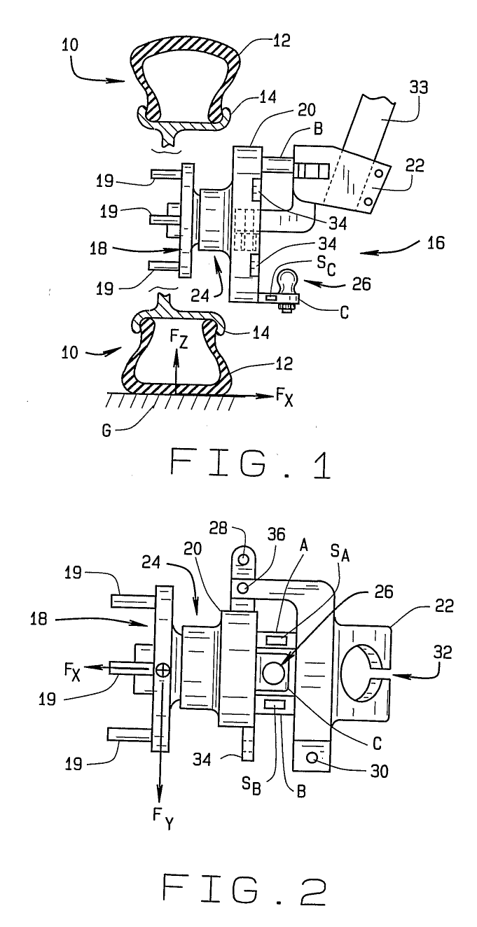

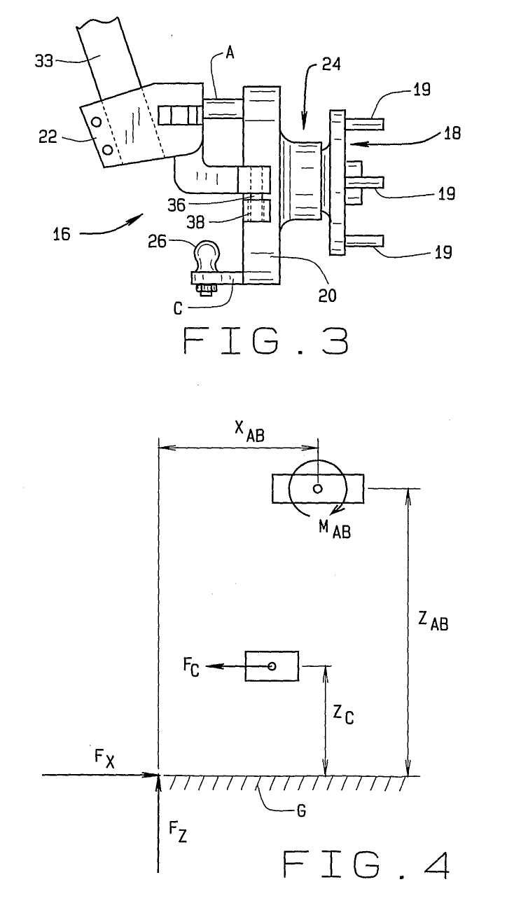

In a first embodiment of the present invention, referring to FIGS. 1-3, a wheel and tire assembly 10 consisting of a tire 12 mounted on a wheel rim 14, is conventionally support on a vehicle 16 by way of a mounting structure consisting of a wheel hub 18 having wheel studs 19, an outer knuckle 20, and an inner knuckle 22. The wheel hub 18 is attached to the outer knuckle 20 by way of a wheel bearing 24. A ball joint 26 is connected to the outer knuckle by means of a beam C that deforms as loads are applied to the ball joint 26. The inner knuckle 22 and the outer knuckle 20 are further connected by beams A and B, best seen in FIG. 2.

Beams A and B are preferably cylindrical, and may be press-fit into both the inner and outer knuckles 22, 20. The inner knuckle 22 may include further attachment points, identified at 28, 30, and 32, for a steering tie rod (not shown), and an anti-sway bar (not shown), and additional suspension members, such as a McPherson strut 33.

To measure forces exerted on the various components, strain sensors S_{A} and S_{B} are disposed on beams A and B, respectively, oriented such that each strain sensor S_{A} and S_{B} is sensitive to bending along a longitudinal axis. A strain sensor S_{C} is similarly disposed on beam C to provide a measure of horizontal forces exerted on the ball joint 26.

Those of ordinary skill in the art will recognize that the specific configuration of the vehicle wheel mounting structure is not limited by the above-description, and in-fact, may be constructed from a variety of different components, or from a unitary body, as required by the specific vehicle application in which the use is intended, provided however, that the vehicle wheel mounting structure is configured with one or more regions which transmit bending loads, and incorporates a set of suitable sensor elements for measuring the bending loads and lateral forces exerted on the wheel mounting structure by the rotating vehicle wheel assembly 10.

Referring again to FIG. 1, vertical forces Fz, exerted on wheel assembly 10 in the contact region between the tire 12 and the surface G cause a primarily horizontal force at the ball joint 26 which is sensed by the sensor S_{C} disposed on beam C. This same vertical force Fz additionally causes a bending of beams A and B along the respective longitudinal axis on which sensors S_{A} and S_{B} are disposed. The bending in each of beams A and B is in the same direction (common mode response).

Referring to FIG. 2, a longitudinal force Fy exerted on the wheel assembly 10 in the contact region between the tire 12 and the surface G causes a transverse load on beam C which is not measured by sensor S_{C}. This same longitudinal force Fy additionally causes a bending of beams A and B along the respective longitudinal axis on which sensors S_{A} and S_{B} are disposed. Beams A and B each respond with opposite vertical bending to the longitudinal force Fy, and hence have a differential mode response.

A lateral wheel contact force Fx, exerted on the wheel assembly 10 in the contact region between the tire 12 and the surface G exerts forces on beams A, B, and C, which may be measured by sensors S_{A}, S_{B}, and S_{C}.

Using a mathematical analysis, measurements of the forces Fx and Fz can be identified from the output of the sensors S_{A}, S_{B}, and S_{C}. The three sensors S_{A}, S_{B}, and S_{C} are sufficient to measure the three axis wheel forces Fx, Fy, and Fz. Because a brake caliper (not shown) may be mounted on tabs 34, located on the outer knuckle 20, braking forces are not carried through the beams A, B, and C. The response of the sensors S_{A}, S_{B}, and S_{C} is not affected by the braking forces, only by the resulting wheel contact forces Fx, Fy, and Fz. Moments about the vertical axis for the tire contact forces Fx, Fy, and Fz, are rejected because they are resisted by longitudinal forces in beams A and B, to which the sensors are not sensitive.

To enable beams A and B to resist excessive bending and to allow for sensors S_{A} and S_{B} to have a high degree of sensitivity, a vertically-oriented pin 36 is pressed into the inner knuckle 22, projecting downward into a receiving bore 38 in the outer knuckle 20. Preferably, there is sufficient clearance between the pin 36 and the bore 38 in the outer knuckle 20 to prevent contact during normal vehicle maneuvering. Under abnormally high loads, the pin 36 contacts the sides of the bore 38, resisting moments that would excessively bend beams A and B.

Separate resolution of the individual forces Fx and Fz from the measurements of the sensors S_{A}, S_{B}, and S_{C} is described below with reference to FIG. 4. The Fy force response from the sensors S_{A}, S_{B}, and S_{C} is independent of the analysis for forces Fx and Fz. Referring to the following equations: Equation (1) calculates the horizontal longitudinal force Fc on beam C; Equation (2) calculates the moment M_{AB} applied to beams A and B together; and Equations (3) and (4) correspond to Equations (1) and (2) rewritten with simple constants.

$$\begin{matrix}{F}_{C} = {F}_{X} \frac{{Z}_{AB}}{{Z}_{AB} - {Z}_{C}} - {F}_{Z} \frac{{X}_{AB}}{{Z}_{AB} - {Z}_{C}} & Equation ( 1 ) \\ {M}_{AB} = {F}_{Z} {X}_{AB} + {F}_{C} ( {Z}_{AB} - {Z}_{C} ) - {F}_{X} {Z}_{AB} & Equation ( 2 ) \\ {F}_{C} = {F}_{X} {c}_{1} + {F}_{Z} {c}_{2} & Equation ( 3 ) \\ {M}_{AB} = {F}_{Z} {c}_{3} + {F}_{C} {c}_{4} + {F}_{X} {c}_{5} & Equation ( 4 )\end{matrix}$$

where:

Z_{AB}, X_{AB}, and Z_{C} represent linear dimensions to the points of measurement;

$${c}_{1} = \frac{{Z}_{AB}}{{Z}_{AB} - {Z}_{C}}$$

$${c}_{2} = - \frac{{X}_{AB}}{{Z}_{AB} - {Z}_{C}}$$

$${c}_{3} = {X}_{AB}$$

$${c}_{4} = {Z}_{AB} - {Z}_{C}$$

$${c}_{5} = - {Z}_{AB}$$

Equation (3) is rearranged to solve for Fx in Equation (5), Equation (4) is rearranged to solve for Fz in Equation (6), and in Equation (7), Equation (5) is inserted into Equation (6) to remove the Fx terms.

$$\begin{matrix}{F}_{X} = \frac{{F}_{C} - {F}_{Z} {c}_{2}}{{c}_{1}} & Equation ( 5 ) \\ {F}_{Z} {c}_{3} = {M}_{AB} - {F}_{C} {c}_{4} - {F}_{X} {c}_{5} \\ {F}_{Z} {c}_{3} = {M}_{AB} - {F}_{C} {c}_{4} - ( \frac{{F}_{C} - {F}_{Z} {c}_{2}}{{c}_{1}} ) {c}_{5} & Equation ( 6 )\end{matrix}$$

Equation (7)

Solving Equation (7) for Fz yields:

$${F}_{Z} = \frac{{M}_{AB} - {F}_{C} ( {c}_{4} + \frac{{c}_{5}}{{c}_{1}} )}{{c}_{3} - \frac{{c}_{2} {c}_{5}}{{c}_{1}}} \qquad Equation ( 8 )$$

The result is that Fz exerted at the contact surface between the tire 12 and the surface G is expressed solely as a function of the measured moments M_{AB} at beams A and B and the force Fc at the beam C of the vehicle mounting structure components.

Those of ordinary skill in the art will recognize that the measurement of the forces and moments at the beams A, B, and C, may be conducted using a variety of types of sensors, and that the resulting measurements or output signals may be routed to a vehicle control unit or processor (not shown) for use in controlling or regulating any of a variety of vehicle functions. These functions may include, but are not limited to, adjustments to vehicle suspension settings, anti-lock braking operations, traction control operations, or vehicle torque distribution operations.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. An improved vehicle wheel mounting including an outer knuckle and an inner knuckle, the outer knuckle supporting a rotating wheel assembly, the inner knuckle being supported by, and aligned with the vehicle by suspension members and linkages, the improvement comprising:
at least a first load sensing element operatively coupled between the inner knuckle and the outer knuckle, said first load sensing element being sensitive to bending moments exerted between said inner knuckle and said outer knuckle in response to one or more lateral, longitudinal, or vertical forces exerted on the wheel assembly at a contact region between the wheel assembly and surface on which the wheel assembly is disposed.

2. The improved vehicle wheel mounting according to claim 1 further including a suspension member attached to the outer knuckle; and
wherein a second load sensing element is operatively disposed to respond to horizontal lateral loads exerted on said suspension member in response to said one or more lateral, longitudinal, or vertical forces exerted on the wheel assembly at said contact region between the wheel assembly and surface on which the wheel assembly is disposed.

3. The improved vehicle wheel mounting according to claim 2 where said first load sensing element includes first and second beams operatively coupling the inner knuckle to the outer knuckle, said first and second beams disposed in a common horizontal plane; and
wherein said first load sensing element further includes at least one strain sensor operatively coupled to the first beam to measure a bending moment along a longitudinal axis of said first beam, and a second strain sensor operatively coupled to the second beam to measure a bending moment along a longitudinal axis of said second beam.

4. The improved vehicle wheel mounting according to claim 1 further including a second load sensing element operatively coupled between the inner knuckle and the outer knuckle, said second load sensing element longitudinally displaced from said first load sensing element and being sensitive to bending moments between said inner and outer knuckles in response to said one or more lateral, longitudinal, or vertical forces exerted on the wheel assembly at said contact region between the wheel assembly and surface on which the wheel assembly is disposed.

5. The improved vehicle wheel mounting according to claim 4 wherein said first and second load sensing elements have a common mode response to said vertical force exerted on the wheel assembly.

6. The improved vehicle wheel mounting according to claim 4 wherein said first and second load sensing elements have a differential mode response to said longitudinal force exerted on the wheel assembly.

7. An improved vehicle wheel mounting according to claim 1 further including a mechanical means for limiting bending deflection between the inner knuckle and the outer knuckle.

8. A method for measuring forces exerted by a vehicle wheel assembly on a vehicle wheel mounting structure, comprising:
measuring a horizontal lateral force at a ball joint attachment point on said vehicle wheel mounting structure;
measuring a bending moment between at least two points on the vehicle wheel mounting structure;
calculating a lateral force exerted on the vehicle wheel assembly from said measured lateral and bending forces;
calculating a vertical force exerted on the vehicle wheel assembly from said measured lateral and bending forces; and
communicating said calculated lateral force and said calculated vertical force to a vehicle control system.

9. The method of claim 8 further including the step of calculating a longitudinal force exerted on the vehicle wheel.

10. The method of claim 8 wherein said lateral force (Fx) exerted on the vehicle wheel is calculated by solving:
$${F}_{X} = \frac{{F}_{C} - {F}_{Z} {c}_{2}}{{c}_{1}}$$
wherein
Fc is a horizontal longitudinal force exerted at said ball joint attachment point;
Fz is the vertical force exerted by the vehicle wheel;
$${c}_{1} = \frac{{Z}_{AB}}{{Z}_{AB} - {Z}_{C}}$$
$${c}_{2} = - \frac{{X}_{AB}}{{Z}_{AB} - {Z}_{C}}$$
Z_{AB} is a vertical distance from the vehicle wheel contact point to an axis about which said bending moment is measured;
X_{AB} is a horizontal distance from the vehicle wheel contact point to said axis about which said bending moment is measured; and
Z_{C} is the vertical distance from the vehicle wheel contact point to said horizontal longitudinal force measurement point.

11. The method of claim 8 wherein said vertical force (Fz) exerted by the vehicle wheel is calculated by solving:
$${F}_{Z} = \frac{{M}_{AB} - {F}_{C} ( {c}_{4} + \frac{{c}_{5}}{{c}_{1}} )}{{c}_{3} - \frac{{c}_{2} {c}_{5}}{{c}_{1}}}$$
wherein
M_{AB} is said bending moment between said two points on the vehicle wheel mounting structure;
Fc is said horizontal longitudinal force exerted at said suspension attachment point;
$${c}_{1} = \frac{{Z}_{AB}}{{Z}_{AB} - {Z}_{C}}$$
$${c}_{2} = - \frac{{X}_{AB}}{{Z}_{AB} - {Z}_{C}}$$
$${c}_{3} = {X}_{AB}$$
$${c}_{4} = {Z}_{AB} - {Z}_{C}$$
$${c}_{5} = - {Z}_{AB}$$
Z_{AB} is a vertical distance from the vehicle wheel contact point to an axis about which said bending moment is calculated;
X_{AB} is a horizontal distance from the vehicle wheel contact point to said axis about which said bending moment is calculated; and
Z_{C} is the vertical distance from the vehicle wheel contact point to said horizontal longitudinal force measurement point.

12. An improved vehicle wheel mounting structure for supporting and coupling a rotatable wheel assembly to a vehicle suspension components, the improvement comprising:
a first region in the vehicle wheel mounting structure subjected to a bending moment between the rotating wheel assembly and the vehicle suspension components;
a first load sensing element operatively coupled to measure said bending moment within said first region, said load sensing element being sensitive to said bending moment to generate a signal representative thereof;
a second region in the vehicle wheel mounting structure subjected to said bending moment between the rotating wheel assembly and the vehicle suspension components, said second region horizontally displaced from said first region;
a second load sensing element operatively coupled to measure said bending moment within said second region, said second load sensing element being sensitive to said bending moment to generate a second signal representative thereof;
a third load sensing element operatively coupled to within said the vehicle wheel mounting structure to generate a signal representative of a lateral force exerted between an attachment point of a vehicle suspension component and the vehicle wheel assembly; and
wherein said generated signals are responsive to at least one force exerted at a contact point between said vehicle wheel assembly and a supporting surface.

13. The improved wheel mounting structure of claim 12 wherein said first and second load sensing elements are strain sensors.
